(19) United States
(12) Patent Application Publication
(10) Pub. No.: US 2024/0097810 A1
(43) Pub. Date: Mar. 21, 2024

(54) AUDIO TRANSMISSION SYSTEM AND SLAVE DEVICE

(71) Applicant: Panasonic Intellectual Property Management Co., Ltd., Osaka (JP)

(72) Inventor: Makoto TAKEMOTO, Kanagawa (JP)

(21) Appl. No.: 18/330,911

(22) Filed: Jun. 7, 2023

(30) Foreign Application Priority Data
Sep. 16, 2022 (JP) 2022-148087

(51) Int. Cl. H04J 3/06; H04L 12/40

(52) U.S. Cl. CPC H04J 3/0647; H04L 12/40019; H04L 2012/40273

(57) ABSTRACT

An audio transmission system performs time-division multiplexing on audio data of N channels (N is an integral number equal to or larger than 1) for each reference period and transmits multiplexed audio data. The N channels represent a number of channels determined in advance in accordance with a preset mode. The audio transmission system includes a master circuit, one or more slave circuits connected to the master circuit via one or more transmission lines by daisy chain topology, and a signal processing circuit. The slave circuits each function as an audio transmitter. The master circuit functions as an audio receiver. The signal processing circuit limits a level of audio data of the N channels to be equal to or smaller than a predetermined value in a case where a level of audio data received by the master circuit is larger than a threshold value.

### CROSS-REFERENCE TO RELATED APPLICATIONS

This application is based upon and claims the benefit of priority from Japanese Patent Application No. 2022-148087, filed on Sep. 16, 2022, the entire contents of which are incorporated herein by reference.

### FIELD

Embodiments described herein relate generally to an audio transmission system and a slave device.

### BACKGROUND

There is a known communication network system provided in a vehicle, which is called Automotive Audio Bus (A2B) (registered trademark) as disclosed in, for example, Japanese Translation of PCT International Application Publication No. 2014-534686 or Japanese Patent Application Laid-open No. 2020-150487. In such a communication network system, nodes connected to audio equipment are connected to each other by two-wire serial wiring, so that wiring cost can be reduced.

The communication network system performs serialization, time-division multiplexing, and transmission of audio data input from each of pieces of audio equipment or of audio data output to each of the pieces of audio equipment. Additionally, the communication network system can change the number of channels of pieces of the audio data to be simultaneously transmitted. For example, the communication network system can set a mode of performing time-division multiplexing and transmission of audio data with 8-channels, a mode of performing time-division multiplexing and transmission of audio data with 32-channels, or the like.

The communication network system changes a bit clock of data to be serially transmitted in accordance with the number of channels of the audio data to be time-division multiplexed. For example, in this communication network system, in a case where bit widths of pieces of the audio data are the same, a frequency of a bit clock in the mode for the 32-channels is set to be four times that in the mode for the 8-channels.

The communication network system includes a master circuit and one or more slave circuits. The master circuit sets the number of channels of the audio data to be time-division multiplexed, by rewriting a value onto a register included in each of the slave circuits.

Meanwhile, bit-flipping (or bit-flip error) may occur in a value stored in the register due to, for example, long-term deterioration. Alternatively, there is a case where the master circuit writes an erroneous value onto the register. In such cases, the number of multiplexing of the master circuit is inconsistent with the number of multiplexing of the slave circuit, and audio output from a speaker may become a big sound. For example, assume a case where the slave circuit operates in the mode of time-division multiplexing and transmitting audio data with the 32-channels and the master circuit operates in a mode of receiving the audio data with the 8-channels. In this case, when the audio data received by the master circuit is output from a speaker, explosive sound may be produced.

### SUMMARY

An audio transmission system according to one aspect of the present disclosure performs time-division multiplexing on audio data of N channels (N is an integral number equal to or larger than 1) for each reference period and transmitting multiplexed audio data. The N channels represent a number of channels determined in advance in accordance with a preset mode. The audio transmission system includes a master circuit, one or more slave circuits, and a signal processing circuit. The one or more slave circuits are connected to the master circuit via one or more transmission lines by daisy chain topology. Each piece of audio data of the N channels corresponds to a different one of the one or more slave circuits. Each piece of audio data of the N channels is assigned to a different one of N transmission/reception periods obtained by time-dividing the reference period. Each of the one or more slave circuits includes a register to store a mode value representing the preset mode. The master circuit writes the mode value onto the register included in each of the one or more slave circuits. Each of the one or more slave circuits generates a bit clock in accordance with the mode value stored in the register, the bit clock being synchronized with a clock of data to be transmitted or received via the one or more transmission lines. Each of the one or more slave circuits serially transmits or receives a corresponding piece of audio data out of pieces of audio data of the N channels to/from the master circuit in the transmission/reception period assigned to the corresponding piece of audio data. Either one of the master circuit and the one or more slave circuits function as an audio transmitter to transmit audio data, and the other one function as an audio receiver to receive audio data. The signal processing circuit limits a level of audio data of the N channels to be equal to or smaller than a predetermined value in a case where a level of audio data received by the audio receiver is larger than a threshold value.

An audio transmission system according to another aspect of the present disclosure performs time-division multiplexing on audio data of N channels (N is an integral number equal to or larger than 1) for each reference period and transmitting multiplexed audio data. The N channels represent a number of channels determined in advance in accordance with a preset mode. The audio transmission system includes a master circuit, one or more slave circuits, and one or more stop circuits. The one or more slave circuits are connected to the master circuit via one or more transmission lines by daisy chain topology. The one or more stop circuits correspond to the one or more slave circuits. Each piece of audio data of the N channels corresponds to a different one of the one or more slave circuits. Each piece of audio data of the N channels is assigned to a different one of N transmission/reception periods obtained by time-dividing the reference period. Each of the one or more slave circuits includes a register to store a mode value representing the preset mode. The master circuit writes the mode value onto the register included in each of the one or more slave circuits. Each of the one or more slave circuits generates a bit clock in accordance with the mode value stored in the register. The bit clock is synchronized with a clock of data to be transmitted or received via the one or more transmission lines. Each of the one or more slave circuits serially transmits a corresponding piece of audio data out of pieces of audio data of the N channels to the master circuit in the transmission/reception period assigned to the corresponding piece of audio data. Each of the one or more stop circuits causes a corresponding one of the one or more slave circuits to stop transmission of audio data to the master circuit in a case where a frequency of the bit clock generated by the corresponding slave circuit falls outside a frequency range set in advance.

### BRIEF DESCRIPTION OF THE DRAWINGS

FIG. 1 is a diagram illustrating a vehicle in which an audio transmission system according to an embodiment is provided;

FIG. 2 is a diagram illustrating a master circuit and one or more slave circuits;

FIG. 3 is a diagram illustrating an example of data transmission in a mode of performing time-division multiplexing on audio data with 8-channels;

FIG. 4 is a diagram illustrating an example of data transmission in a mode of performing time-division multiplexing on audio data with 32-channels;

FIG. 5 is a diagram illustrating an example of a mode value stored in a register of the slave circuit in the mode of performing time-division multiplexing on audio data with 8-channels;

FIG. 6 is a diagram illustrating an example of the mode value stored in the register of the slave circuit in the mode of performing time-division multiplexing on audio data with 32-channels;

FIG. 7 is a diagram illustrating a list of mode values;

FIG. 8 is a diagram illustrating a configuration of an audio transmission system according to a first example;

FIG. 9 is a flowchart illustrating a procedure of processing for limiting output of audio data;

FIG. 10 is a diagram illustrating a frequency characteristic of background noise in a room in a case where modes are consistent with each other;

FIG. 11 is a diagram illustrating an RMS level of background noise in a room in a case where modes are consistent with each other;

FIG. 12 is a diagram illustrating a frequency characteristic of background noise in a room in a case where modes are inconsistent with each other;

FIG. 13 is a diagram illustrating an RMS level of background noise in a room in the case where the modes are inconsistent with each other;

FIG. 14 is a diagram illustrating a configuration of a slave device according to a modification;

FIG. 15 is a flowchart illustrating a procedure of processing for limiting output of audio data performed by a stop circuit;

FIG. 16 is a diagram illustrating a configuration of an audio transmission system according to a second example;

FIG. 17 is a diagram illustrating a configuration of an audio transmission system according to a third example;

FIG. 18 is a diagram illustrating a configuration of an audio transmission system according to a fourth example; and

FIG. 19 is a diagram illustrating a configuration of an audio transmission system according to a fifth example.

### DETAILED DESCRIPTION

The following describes an embodiment of an audio transmission system 20 according to the present disclosure with reference to the drawings.

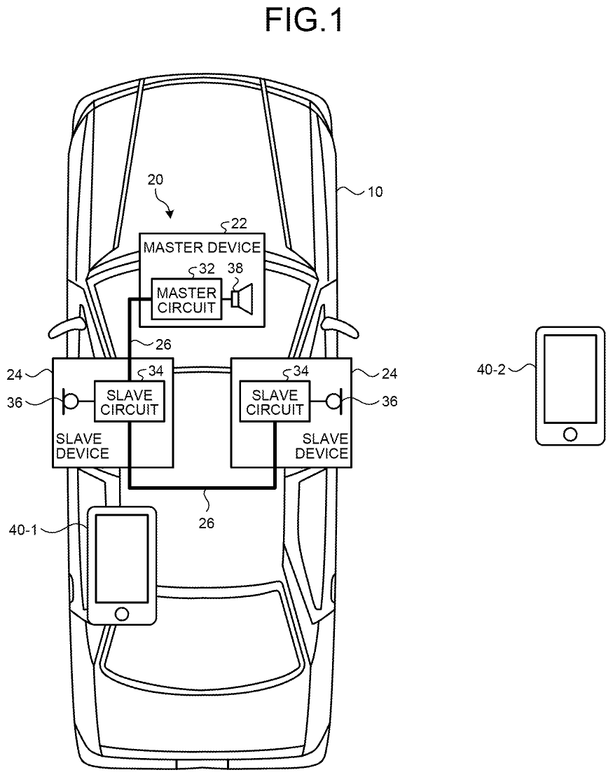

FIG. 1 is a diagram illustrating a vehicle 10 in which the audio transmission system 20 according to the embodiment is provided.

The audio transmission system 20 is provided in the vehicle 10, for example. The audio transmission system 20 includes a master device 22 and one or more slave devices 24. The one or more slave devices 24 are connected to the master device 22 via one or more transmission lines 26 by daisy chain topology.

The master device 22 is provided in the vehicle 10, for example. Each of the one or more slave devices 24 is provided in the vicinity of each seat in the vehicle 10.

The master device 22 includes a master circuit 32 for transmitting and receiving data via the one or more transmission lines 26. Each of the one or more slave devices 24 includes a slave circuit 34 for transmitting and receiving data via the one or more transmission lines 26.

One or more pieces of audio equipment are connected to each of the one or more slave circuits 34. In a case where the connected audio equipment is a microphone 36, each of the one or more slave circuits 34 acquires audio data representing audio collected by the microphone 36 and transmits the acquired audio data to the master circuit 32 via the one or more transmission lines 26. In a case where the connected audio equipment is a speaker 38, each of the one or more slave circuits 34 receives, from the master circuit 32 via the one or more transmission lines 26, audio data representing audio to be output from the speaker 38 and causes the speaker 38 to output audio corresponding to the received audio data.

One or more pieces of the audio equipment may be connected also to the master circuit 32. In a case where the connected audio equipment is the speaker 38, the master circuit 32 receives audio data from each of the one or more slave circuits 34 via the one or more transmission lines 26 and causes the speaker 38 to output audio corresponding to the received audio data. In a case where the connected audio equipment is the microphone 36, the master circuit 32 acquires audio data representing audio collected by the microphone 36 and transmits the acquired audio data to part of or all the one or more slave circuits 34 via the one or more transmission lines 26.

An information processing device 40-1 inside the vehicle 10 such as a smartphone may be connected to the master circuit 32 via a communication line of a predetermined communication standard such as Bluetooth (registered trademark). In this case, the master circuit 32 receives audio data from each of the one or more slave circuits 34 via the one or more transmission lines 26, and transmits the received audio data to the information processing device 40-1 inside the vehicle 10 via the communication line. Additionally, the information processing device 40-1 inside the vehicle 10 transmits the audio data to an information processing device 40-2 such as a smartphone outside the vehicle 10 via a public network, for example. Due to this, a user carrying the information processing device 40-2 outside the vehicle 10 can hear audio (voice, utterance, etc.) of a passenger in the vehicle 10.

The information processing device 40-2 outside the vehicle 10 may transmit the audio data to the information processing device 40-1 inside the vehicle 10 via a public network, for example. In this case, the information processing device 40-1 inside the vehicle 10 transmits the audio data to the master circuit 32 via the communication line. The master circuit 32 then acquires the audio data from the information processing device 40-1 of the vehicle 10, and transmits the acquired audio data to part of or all the one or more slave circuits 34 via the one or more transmission lines 26. Due to this processing, the passenger of the vehicle 10 can hear audio of the user carrying the information processing device 40-2 outside the vehicle 10.

The audio transmission system 20 as described above is able to collect audio (voice, utterance, etc.) uttered by a passenger other than a driver in the vehicle 10. The audio transmission system 20 is also able to output the collected audio to the driver, or output the collected audio to a user carrying the information processing device 40-2 outside the vehicle 10. Alternatively, for example, the audio transmission system 20 is able to output audio uttered by the driver or audio uttered by the user carrying the information processing device 40-2 outside the vehicle 10 to the passenger other than the driver in the vehicle.

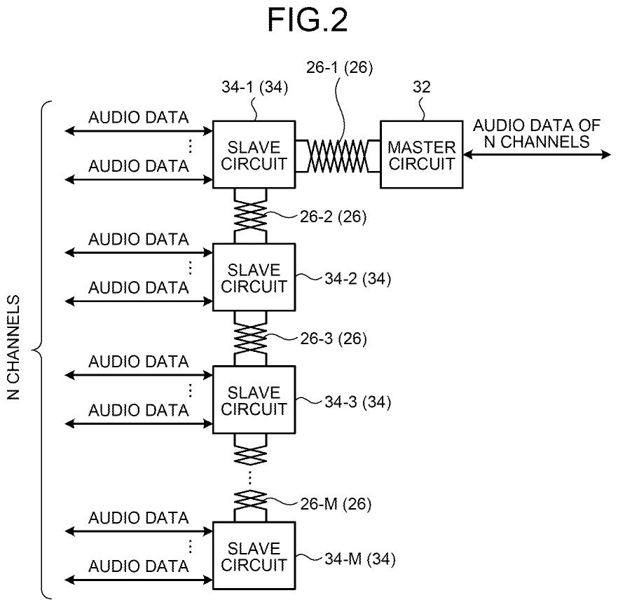

FIG. 2 is a diagram illustrating the master circuit 32 and the one or more slave circuits 34. In the present embodiment, the master circuit 32 is connected to the one or more slave circuits 34 on the basis of a communication network system in the vehicle that is called A2B (registered trademark). The master circuit 32 may be connected to the one or more slave circuits 34 on the basis of a similar type of a communication network system instead of A2B.

The one or more slave circuits 34 are connected to the master circuit 32 via the one or more transmission lines 26 by the daisy chain scheme. For example, it is assumed that the audio transmission system 20 includes M (M is an integral number equal to or larger than 1) slave circuits 34 consisting of a first slave circuit 34-1 to an M-th slave circuit 34-M. In this case, the master circuit 32 is connected to the first slave circuit 34-1 via a first transmission line 26-1. The first slave circuit 34-1 is connected to a second slave circuit 34-2 via a second transmission line 26-2. The second slave circuit 34-2 is connected to a third slave circuit 34-3 via a third transmission line 26-3. An (M−1)-th slave circuit 34-(M−1) is connected to the M-th slave circuit 34-M via an M-th transmission line 26-M.

Each of the one or more transmission lines 26 is a two-wire transmission line that transmits serial data. The one or more transmission lines 26 transmit data output from the master circuit 32 to each of the one or more slave circuits 34. The one or more transmission lines 26 also transmit data output from each of the one or more slave circuits 34 to the master circuit 32.

The audio transmission system 20 performs time-division multiplexing on audio data of N channels (N is an integral number equal to or larger than 1) and transmits the multiplexed audio data via the one or more transmission lines 26. The N channels represent the number of channels that is determined in accordance with a preset mode for each reference period determined in advance. Each piece of audio data of the N channels corresponds to a different one of the one or more slave circuits 34.

Each of the one or more slave circuits 34 inputs/outputs a piece of audio data of a corresponding channel out of pieces of audio data of the N channels from/to an external device. Each of the one or more slave circuits 34 may input/output audio data of one channel, or may input/output audio data of two or more channels. On the other hand, the master circuit 32 inputs/outputs all pieces of audio data of the N channels to the external device.

The audio transmission system 20 as described above changes the number of channels of audio data of the N channels in accordance with a preset mode. For example, any of a TDM2 mode of time-division multiplexing and transmitting audio data of 2-channels, a TDM4 mode of time-division multiplexing and transmitting audio data of 4-channels, a TDM8 mode of time-division multiplexing and transmitting audio data of 8-channels, a TDM16 mode of time-division multiplexing and transmitting audio data of 16-channels, and a TDM32 mode of time-division multiplexing and transmitting audio data of 32-channels is set for the audio transmission system 20.

Either one of the master circuit 32 and the one or more slave circuits 34 function as an audio transmitter to transmit the audio data, and the other one function as an audio receiver to receive the audio data. For example, in a case where the master circuit 32 functions as the audio transmitter, each of the one or more slave circuits 34 functions as the audio receiver. In a case where the master circuit 32 functions as the audio receiver, each of the one or more slave circuits 34 functions as the audio transmitter.

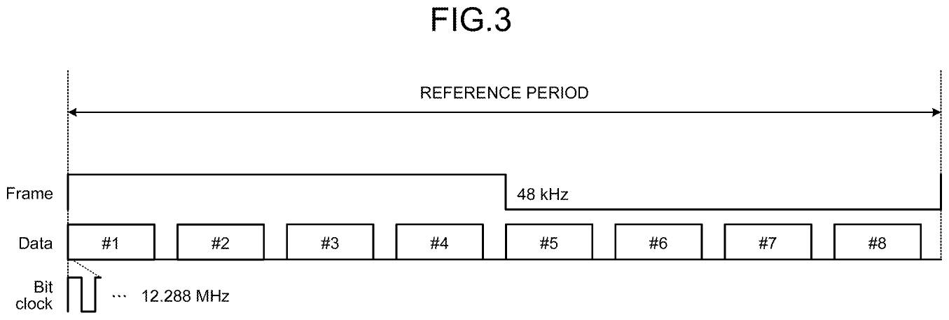

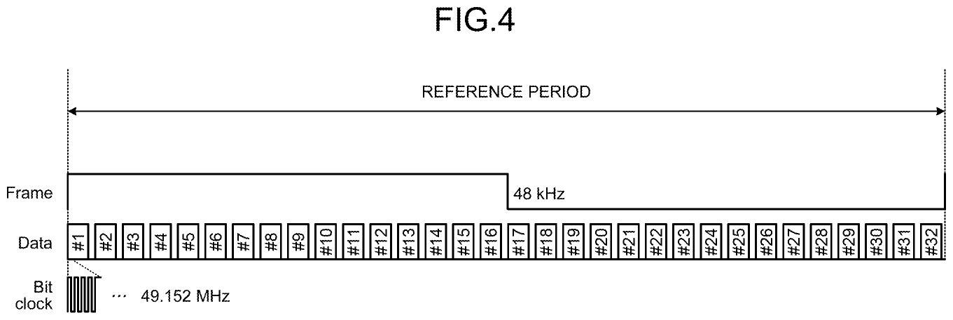

FIG. 3 and FIG. 4 are diagrams illustrating an example of data transmission. More specifically, FIG. 3 is a diagram illustrating an example of data transmission in a mode of performing time-division multiplexing on audio data with 8-channels. FIG. 4 is a diagram illustrating an example of data transmission in a mode of performing time-division multiplexing on audio data with 32-channels.

The audio transmission system 20 performs time-division multiplexing and transmission of serial audio data of N channels for each reference period determined in advance. The reference period may be a sampling period of the audio data, for example. In this example, the reference period is 48 kHz.

The master circuit 32 transmits a synchronization signal synchronized with the reference period to the one or more slave circuits 34 via the one or more transmission lines 26. Due to this, each of the master circuit 32 and the one or more slave circuits 34 can operate in synchronization with the reference period.

Each piece of audio data of the N channels is assigned to a different one of N transmission/reception periods obtained by time-dividing the reference period, and is transmitted in an assigned transmission/reception period. The transmission/reception periods are assigned to respective pieces of audio data of the N channels not to overlap with each other within the reference period. The master circuit 32 and the one or more slave circuits 34 then serially transmit or receive a corresponding piece of audio data out of pieces of audio data of the N channels in the transmission/reception period assigned to the corresponding piece of audio data.

For example, as illustrated in FIG. 3, in the mode of performing time-division multiplexing on audio data of 8-channels, eight transmission/reception periods (#1 to #8) obtained by dividing the reference period into eight periods are set. In this mode, the master circuit 32 and the one or more slave circuits 34 transmit or receive the first audio data out of audio data of 8-channels in a transmission/reception period (#1) of a first channel. The master circuit 32 and the one or more slave circuits 34 also transmit or receive the second audio data out of the audio data of 8-channels in a transmission/reception period (#2) of a second channel, and transmit or receive the eighth audio data in a transmission/reception period (#8) of an eighth channel.

For example, as illustrated in FIG. 4, in a mode of performing time-division multiplexing on audio data of 32-channels, thirty-two transmission/reception periods (#1 to #32) obtained by dividing the reference period into thirty-two periods are set. In this mode, the master circuit 32 and the one or more slave circuits 34 transmit or receive the first audio data out of audio data of 32-channels in a transmission/reception period (#1) of a first channel. The master circuit 32 and the one or more slave circuits 34 also transmit or receive the second audio data out of the audio data of 32-channels in a transmission/reception period (#2) of a second channel, and transmit or receive the thirty-second audio data in a transmission/reception period (#32) of a thirty-second channel.

Due to this, the audio transmission system 20 can perform time-division multiplexing and transmission of the serial audio data of N channels that represent the number of channels determined in accordance with the preset mode for each reference period.

Each of the one or more slave circuits 34 generates a bit clock and a frame signal. The bit clock is a signal synchronized with a clock of data transmitted/received via the one or more transmission lines 26. The frame signal is a logic signal synchronized with the reference period, and logic is reversed every ½ period. The frame signal is not limited to the signal whose logic is reversed every ½ period. The frame signal may be any signal as long as the reference period can be detected.

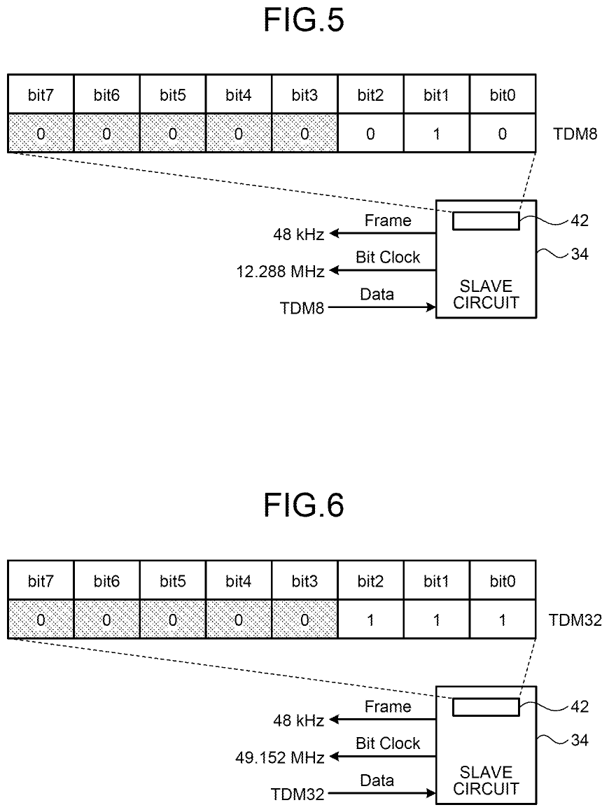

FIG. 5 and FIG. 6 are diagrams illustrating an example of a mode value stored in a register 42 of the slave circuit 34. More specifically, FIG. 5 is a diagram illustrating an example of a mode value stored in the register 42 of the slave circuit 34 in the mode of performing time-division multiplexing on audio data with 8-channels. FIG. 6 is a diagram illustrating an example of the mode value stored in the register 42 of the slave circuit 34 in the mode of performing time-division multiplexing on audio data with 32-channels.

Each of the one or more slave circuits 34 includes the register 42 that stores the mode value representing the mode. The master circuit 32 writes the mode value onto the register 42 included in each of the one or more slave circuits 34 at the time, for example, before transmitting/receiving audio data.

Each of the one or more slave circuits 34 then generates a bit clock in accordance with the mode value stored in the register 42 and the synchronization signal. the bit clock is synchronized with a clock of data to be transmitted/received via the one or more transmission lines 26. For example, each of the one or more slave circuits 34 generates a bit clock having a frequency that is calculated based on the following expression (1).

Frequency of bit clock=(frequency of reference period)×(bit width of data transmitted during one reference period)×(number of channels (N)) (1)

For example, in the mode of time-division multiplexing the audio data of 8-channels in FIG. 5, N=8, the frequency of the reference period is 48 kH, and the bit width is 32 bits. Thus, in this mode, the frequency of the bit clock is 12.288 MHz.

For example, in the mode of time-division multiplexing the audio data of 32-channels in FIG. 6, N=32, the frequency of the reference period is 48 kH, and the bit width is 32 bits. Thus, in this mode, the frequency of the bit clock is 49.152 MHz.

For example, as illustrated in FIG. 5, in a case where a mode value indicating “00000010” is written onto the register 42, the slave circuit 34 operates in the TDM8 mode of time-division multiplexing the audio data of 8-channels. For example, as illustrated in FIG. 6, in a case where a mode value indicating “00000111” is written onto the register 42, the slave circuit 34 operates in the TDM32 mode of time-division multiplexing the audio data of 32-channels.

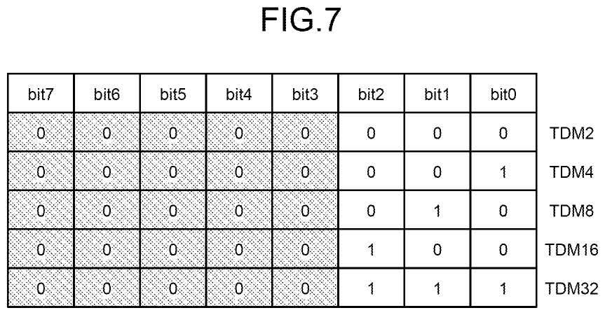

FIG. 7 is a diagram illustrating a list of mode values stored in the register 42 of the slave circuit 34. For example, the master circuit 32 stores a list representing mode values for respective modes as illustrated in FIG. 7. Before transmitting/receiving the audio data, the master circuit 32 writes the mode value corresponding to the mode to be set as illustrated in FIG. 7 onto the register 42 included in each of the one or more slave circuits 34. Due to this, the master circuit 32 and each of the one or more slave circuits 34 can transmit/receive the audio data to/from each other in the same mode.

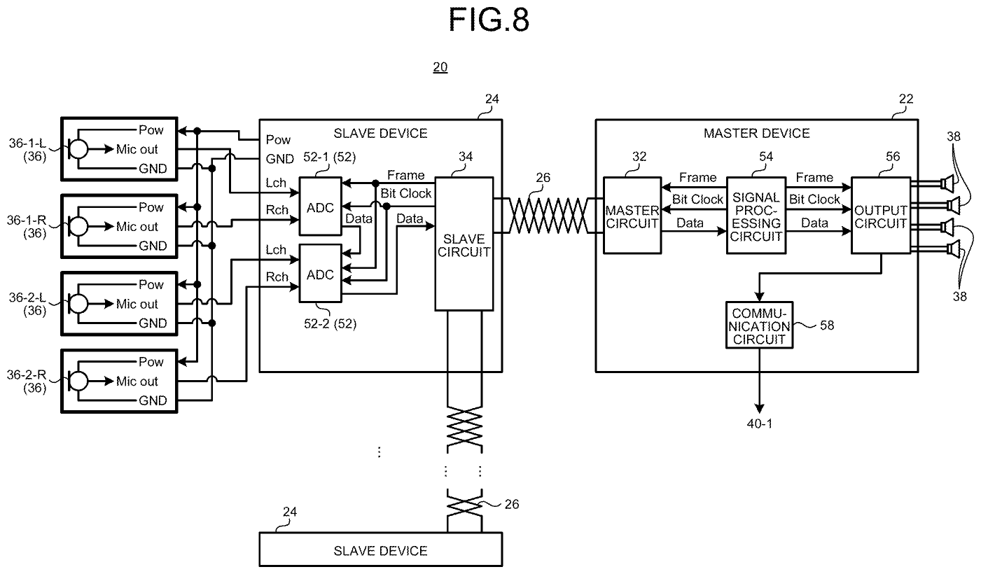

FIG. 8 is a diagram illustrating a configuration of the audio transmission system 20 according to a first example.

The audio transmission system 20 according to the first example includes the microphones 36, the master device 22, the one or more slave devices 24, the one or more transmission lines 26, and the speakers 38.

Each of the microphones 36 collects audio and outputs an analog audio signal representing the collected audio. Each of the microphones 36 corresponds to a different one of the one or more slave devices 24. Each of the microphones 36 according to the first example is a three-terminal type and includes a power supply terminal (Pow), a ground terminal (GND), and a signal output terminal (Mic out). The power supply terminal and the ground terminal of each of the microphones 36 according to the first example are connected to the corresponding slave device 24, and each of the microphones 36 receives supply of DC power (Pow) from the corresponding slave device 24. Each of the microphones 36 according to the first example outputs the analog audio signal from the signal output terminal (Mic out) to the corresponding slave device 24.

In the present embodiment, a group of a first L-channel microphone 36-1-L and a first R-channel microphone 36-1-R, and a group of a second L-channel microphone 36-2-L and a second R-channel microphone 36-2-R, are connected to each of the one or more slave devices 24. Thus, in the present embodiment, the four microphones 36 are connected to each of the one or more slave devices 24.

In the audio transmission system 20 according to the first example described above, each piece of audio data of the N channels represents audio collected by any one of the microphones 36.

Each of the one or more slave devices 24 includes one or more analog-to-digital converters (ADCs) 52, and the slave circuit 34.

Each of the one or more ADCs 52 in each slave device 24 corresponds to one or more of the microphones 36. Each ADC 52 performs analog-to-digital conversion on an audio signal output from each of the one or more corresponding microphones 36 at each sampling timing, and generates one or more pieces of audio data synchronized with a bit clock at each sampling timing. Each ADC 52 then gives the generated one or more pieces of audio data to the slave circuit 34.

In addition, each ADC 52 receives the frame signal and the bit clock from the slave circuit 34. Each ADC 52 performs sampling at a timing of a rising edge or a falling edge of the frame signal. Each ADC 52 then outputs serial audio data synchronized with the bit clock.

In the present embodiment, each of the one or more slave devices 24 includes a first ADC 52-1 and a second ADC 52-2. The first ADC 52-1 performs analog-to-digital conversion on an audio signal output from the first L-channel microphone 36-1-L and on an audio signal output from the first R-channel microphone 36-1-R, and outputs serial audio data. The second ADC 52-2 performs analog-to-digital conversion on each of an audio signal output from the second L-channel microphone 36-2-L and on an audio signal output from the second R-channel microphone 36-2-R, and outputs serial audio data.

The slave circuit 34 receives a plurality of pieces of the audio data output from the one or more ADCs 52 in synchronization with the bit clock for each reference period. The slave circuit 34 then transmits each of the pieces of audio data to the master circuit 32 via the one or more transmission lines 26 in synchronization with the bit clock in the transmission/reception period assigned to the audio data for each reference period. In this way, in the first example, the slave circuit 34 functions as the audio transmitter to transmit audio data.

The master device 22 includes the master circuit 32, a signal processing circuit 54, an output circuit 56, and a communication circuit 58.

The master circuit 32 receives the frame signal and the bit clock from the signal processing circuit 54. The master circuit 32 receives audio data of the N channels transmitted to the one or more transmission lines 26 in the N transmission/reception periods for each reference period, on the basis of the frame signal and the bit clock received from the signal processing circuit 54. The master circuit 32 transmits audio data of the N channels to the signal processing circuit 54 in synchronization with the bit clock. In this manner, the master circuit 32 in the first example functions as the audio receiver that receives the audio data.

The signal processing circuit 54 receives audio data of the N channels from the master circuit 32 and performs predetermined audio signal processing on each piece of the received audio data of N channels. The signal processing circuit 54 gives, to the output circuit 56, audio data of the N channels subjected to the audio signal processing together with the frame signal and the bit clock.

The output circuit 56 receives each piece of audio data of the N channels from the signal processing circuit 54. The output circuit 56 performs digital-to-analog conversion on respective pieces of audio data of the N channels received from the signal processing circuit 54 to generate audio signals of N channels. The output circuit 56 causes the speaker 38 to output each of the generated audio signals of N channels.

Each of the speakers 38 receives the audio signal from the output circuit 56. Each of the speakers 38 outputs audio corresponding to the audio signal received from the output circuit 56.

The communication circuit 58 acquires, from the output circuit 56, audio data of at least one channel out of the pieces of audio data of N channels. The communication circuit 58 transmits the acquired audio data of at least one channel out of the pieces of audio data of N channels to the information processing device 40-1 via a communication bus. Due to this, the communication circuit 58 can output the audio data of at least one channel out of the pieces of audio data of N channels to the information processing device 40-1. In a case where the information processing device 40-1 is not connected to the audio transmission system 20, the communication circuit 58 does not output the audio data.

Note that, in a case where a level of a piece of the audio data out of the pieces of audio data of N channels received by the master circuit 32 is larger than a threshold value, the signal processing circuit 54 limits a level of audio data of the N channels to be equal to or lower than a predetermined level.

For example, the signal processing circuit 54 determines whether a level of any of the pieces of audio data of N channels is larger than the threshold value for each reference period. In a case where there is any piece of audio data of N channels, whose level is larger than the threshold value, the signal processing circuit 54 limits the level of audio data of the N channels to be equal to or lower than the predetermined level thereafter.

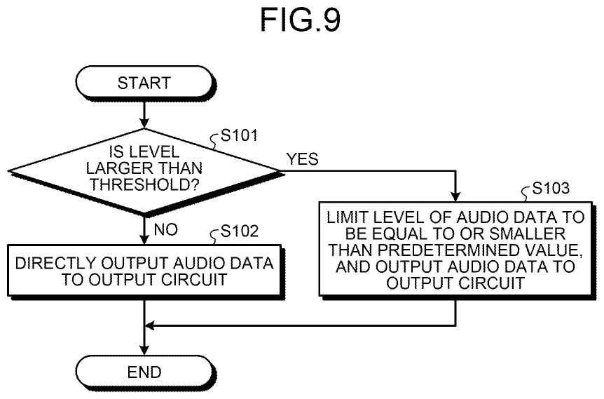

FIG. 9 is a flowchart illustrating a procedure of processing for limiting output of the audio data performed by the signal processing circuit 54.

The signal processing circuit 54 performs the processing through the procedure illustrated in FIG. 9 for each reference period, for example.

First, at S101, the signal processing circuit 54 determines whether a level of each of the audio signals of N channels is larger than a threshold value set in advance.

In a case where there is no piece of audio data of the N channels, whose level is larger than the threshold value (No at S101), the signal processing circuit 54 advances the process to S102. At S102, the signal processing circuit 54 outputs the pieces of audio data of N channels to the output circuit 56 while keeping the levels as they are. After finishing the processing at S102, the signal processing circuit 54 ends the processing flow.

In a case where level of any piece of audio data of N channels is larger than the threshold value (Yes at S101), the signal processing circuit 54 advances the process to S103. At S103, the signal processing circuit 54 limits the level of the audio data, whose level is larger than the threshold value to be equal to or smaller than a predetermined value, and outputs the audio data to the output circuit 56. In this case, the signal processing circuit 54 may output, without limitation, audio data other than the audio data whose level is larger than the threshold value, or may output audio data other than the audio data whose level is larger than the threshold value while limiting the level thereof to be equal to or smaller than the predetermined value. After finishing the processing at S103, the signal processing circuit 54 ends the processing flow.

At S103, alternatively, the signal processing circuit 54 may stop output of any piece of audio data of N channels, whose level is larger than the threshold value. In this case, the signal processing circuit 54 may stop output of all pieces of audio data of the N channels.

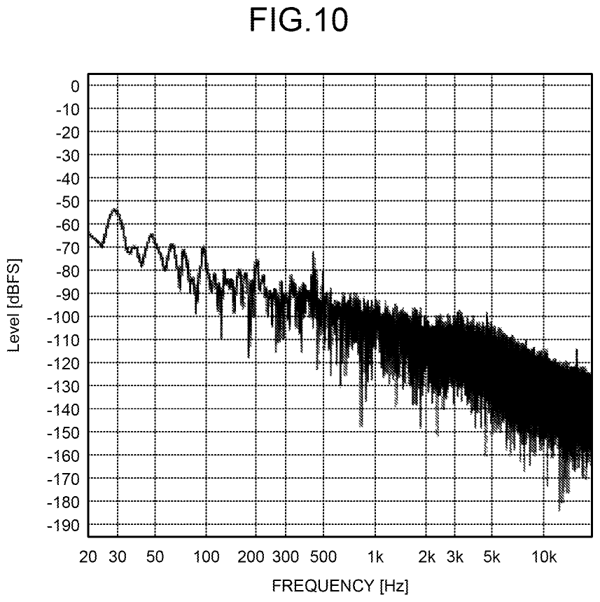

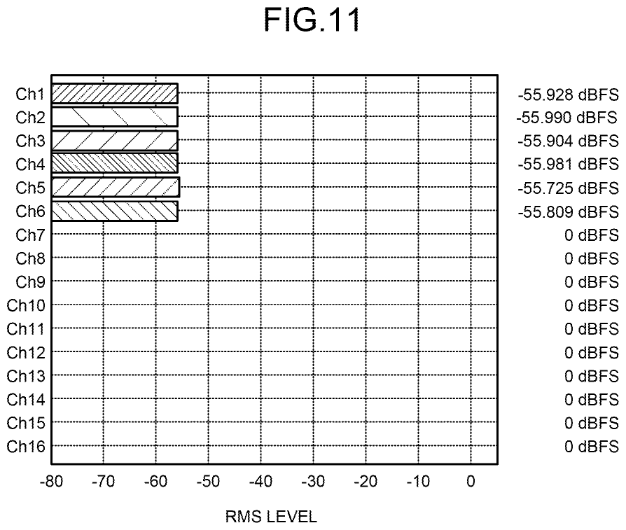

FIG. 10 is a diagram illustrating a frequency characteristic of background noise in a room in a case where modes are consistent with each other. FIG. 11 is a diagram illustrating an RMS level of background noise in the room in a case where modes are consistent with each other. More specifically, FIG. 10 and FIG. 11 are diagrams illustrating the frequency characteristic and the RMS level of the background noise in the room in a case where each of the one or more slave circuits 34 outputs audio data corresponding to six-channels with a bit clock corresponding to the mode of time-division multiplexing the audio data of 8-channels (TDM8), and the master circuit 32 receives audio data with a bit clock corresponding to TDM8.

As illustrated in FIG. 10 and FIG. 11, when a mode of each of the one or more slave circuits 34 is consistent with a mode of the master circuit 32, the audio transmission system 20 can output audio at a level in a normal range.

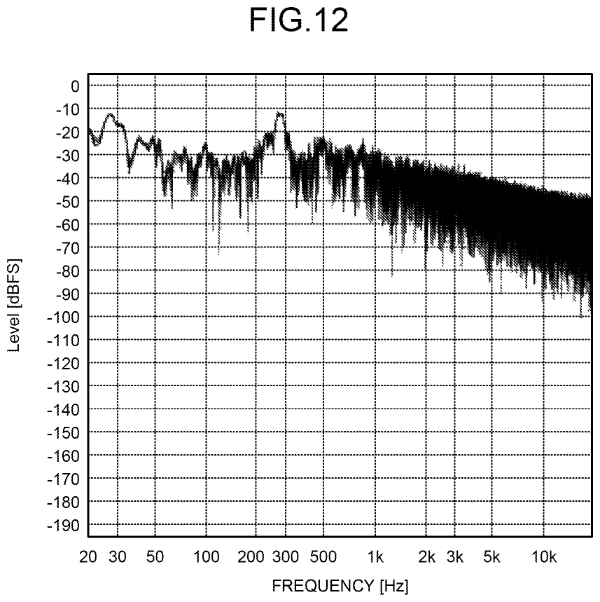

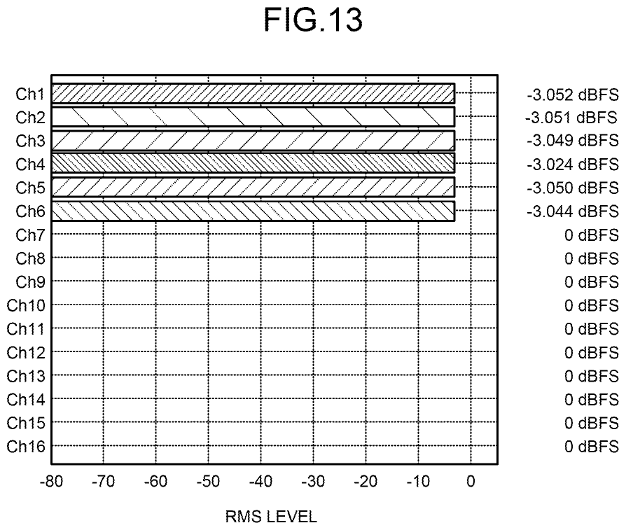

FIG. 12 is a diagram illustrating a frequency characteristic of the background noise in the room in a case where modes are inconsistent with each other between the master circuit 32 and the slave circuit 34. FIG. 13 is a diagram illustrating the RMS level of the background noise in the room in the case where the modes are inconsistent with each other. More specifically, FIG. 12 and FIG. 13 are diagrams illustrating the frequency characteristic and the RMS level of the background noise in the room in a case where each of the one or more slave circuits 34 outputs audio data with a bit clock corresponding to the mode of time-division multiplexing the audio data of 32-channels (TDM32), while the master circuit 32 receives audio data with a bit clock corresponding to TDM8.

A mode value representing a mode is written by the master circuit 32 onto the register 42 included in each of the one or more slave circuits 34. However, for example, in a case where the master circuit 32 writes an erroneous value onto the register 42, or in a case where a bit change occurs in a value written onto the register 42 due to long-term deterioration of the slave circuit 34 or the like, inconsistency between the modes is caused. Specifically, for example, if the master circuit 32 erroneously writes a mode value of “00000111” indicating TDM32 onto the register 42 included in each of the one or more slave circuits 34 although a mode value of “00000010” indicating TDM8 should be written, the background noise in the room exhibits characteristics as illustrated in FIG. 12 and FIG. 13.

As illustrated in FIG. 12 and FIG. 13, in a case where modes are inconsistent with each other, the RMS level of the audio data of each channel increases to be about −3 dBFS in the audio transmission system 20. Therefore, in the audio transmission system 20, when the audio data is directly output from the signal processing circuit 54 to the output circuit 56, noise with loud volume is output from the speaker 38 or from the information processing device 40-2 outside the vehicle 10.

According to the present embodiment, in a case where the level of any piece of audio data out of the pieces of audio data of N channels is larger than the threshold value, the signal processing circuit 54 limits the level of audio data of the N channels to be equal to or lower than the predetermined level. With this processing, the audio transmission system 20 according to the present embodiment is able to prevent output of audio with loud volume.

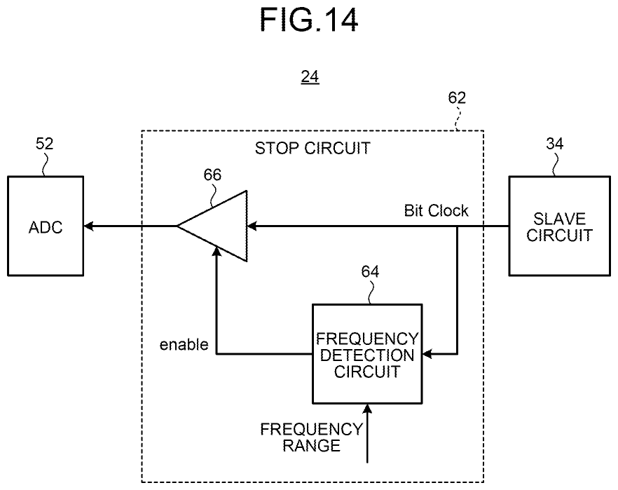

FIG. 14 is a diagram illustrating a configuration of the slave device 24 according to a modification.

In the audio transmission system 20, each of the one or more slave devices 24 may further include a stop circuit 62. In a case where the frequency of the bit clock generated by the slave circuit 34 falls outside a preset range, the stop circuit 62 causes the slave circuit 34 to stop transmission of the audio data to the master circuit 32 via the one or more transmission lines 26.

For example, the stop circuit 62 includes a frequency detection circuit 64 and a buffer circuit 66.

A frequency range is set in advance for the frequency detection circuit 64. The frequency range may be set with an upper limit value and a lower limit value, or may be a specific value, or may be set only the upper limit value.

The frequency range is set by, for example, a designer, a manufacturer, or the like of the audio transmission system 20. In a case where the audio transmission system 20 is installed in the vehicle 10, the microphones 36 or the speakers 38 are fixed, and the number thereof is not changed. Due to this, in a case where the audio transmission system 20 is installed in the vehicle 10, the number of channels of audio data to be time-division multiplexed is fixed in accordance with the number of the microphones 36 or the speakers 38. Thus, in the vehicle 10, the audio transmission system 20 is used in a mode determined in advance in a fixed manner. Accordingly, the frequency range is set to be a range including a frequency of a bit clock in the mode determined in advance used for the audio transmission system 20.

The frequency detection circuit 64 acquires the bit clock generated by the slave circuit 34. The frequency detection circuit 64 then detects the frequency of the acquired bit clock. For example, the frequency detection circuit 64 detects the frequency of the bit clock by counting the bit clock for each period determined in advance.

The frequency detection circuit 64 outputs an enable signal representing ON or OFF. In a case where the detected frequency of the bit clock falls within the frequency range set in advance, the frequency detection circuit 64 turns on the enable signal. In a case where the detected frequency of the bit clock falls outside the frequency range set in advance, the frequency detection circuit 64 turns off the enable signal.

The buffer circuit 66 acquires the bit clock generated by the slave circuit 34 and gives the acquired bit clock to the one or more ADCs 52. Moreover, the buffer circuit 66 receives the enable signal from the frequency detection circuit 64. In a case where the received enable signal is in an ON state, the buffer circuit 66 directly gives the bit clock to the one or more ADCs 52. In a case where the received enable signal is in an OFF state, the buffer circuit 66 stops output of the bit clock.

Each of the one or more ADCs 52 outputs the audio data in synchronization with the bit clock. Due to this, in a case where the buffer circuit 66 stops output of the bit clock, each of the one or more ADCs 52 stops output of the audio data.

Thus, the stop circuit 62 having the configuration as described above can stop transmission of the audio data to the master circuit 32 by the slave circuit 34 in a case where the frequency of the bit clock generated by the slave circuit 34 falls outside the range set in advance.

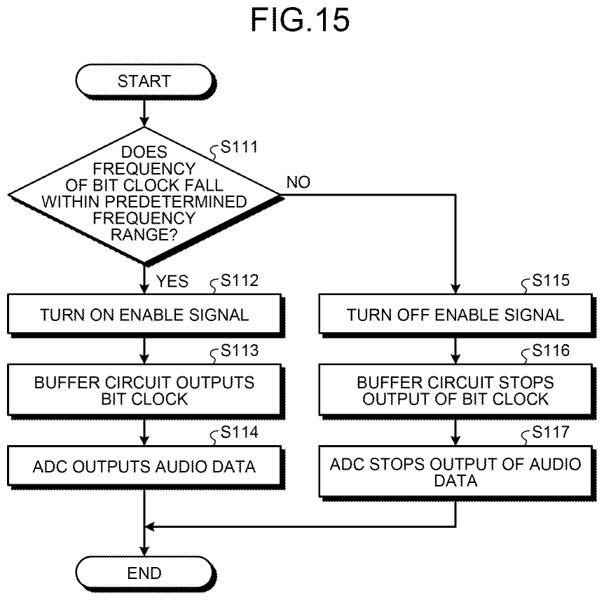

FIG. 15 is a flowchart illustrating a procedure of processing for limiting output of the audio data performed by the stop circuit 62. Each of the one or more slave devices 24 performs the processing through the procedure illustrated in FIG. 15 for each frequency detection period, for example.

First, at S111, the frequency detection circuit 64 determines whether the frequency of the bit clock generated by the slave circuit 34 falls within the frequency range set in advance.

In a case where the frequency of the bit clock falls within the frequency range set in advance (Yes at S111), the frequency detection circuit 64 advances the process to S112.

At S112, the frequency detection circuit 64 turns on the enable signal. Subsequently, at S113, the buffer circuit 66 outputs the bit clock generated by the slave circuit 34 to each of the one or more ADCs 52. Subsequently, at S114, each of the one or more ADCs 52 samples the audio signal and outputs the audio signal synchronized with the bit clock. Then, the ADC 52 ends the processing flow in this procedure. With this processing, the slave circuit 34 is able to transmit the audio data to the master circuit 32.

On the other hand, if the frequency of the bit clock falls outside the frequency range set in advance (No at S111), the frequency detection circuit 64 advances the process to S115.

At S115, the frequency detection circuit 64 turns off the enable signal. Subsequently, at S116, the buffer circuit 66 stops output of the bit clock generated by the slave circuit 34 to the one or more ADCs 52. Subsequently, at S117, each of the one or more ADCs 52 stops output of the audio data, and ends the processing flow in this procedure. Due to this, the slave circuit 34 can stop transmission of the audio data to the master circuit 32.

Additionally, even when each of the one or more slave devices 24 includes the stop circuit 62 described above, the audio transmission system 20 can stop output of the audio in a case where modes are inconsistent with each other. Thus, by providing the stop circuit 62 described above, the audio transmission system 20 can prevent output of audio with loud volume.

In a case where each of the one or more slave devices 24 includes the stop circuit 62, the signal processing circuit 54 does not necessarily perform processing of limiting output of the audio signals of N channels in a case where the level of each of the audio signals of N channels is larger than the threshold value set in advance.

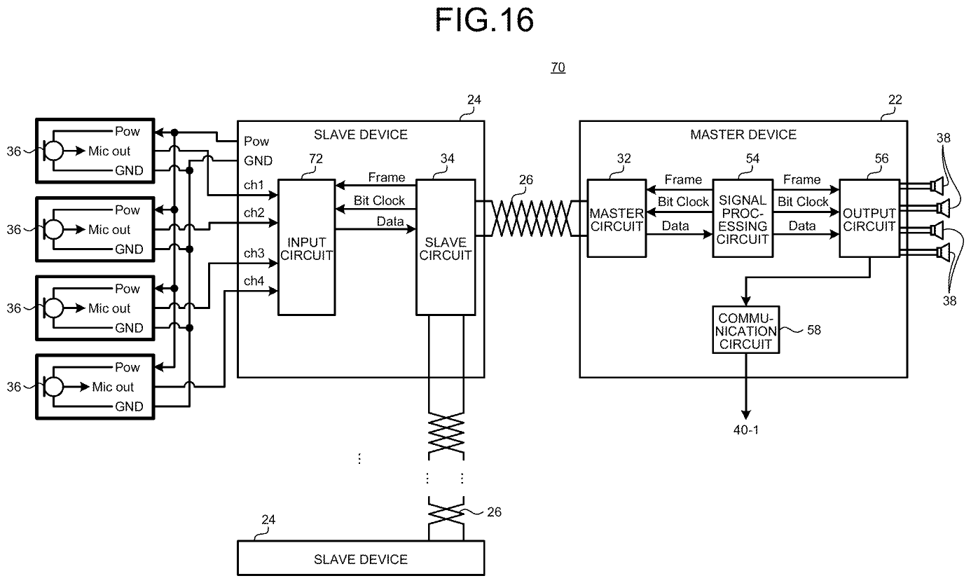

FIG. 16 is a diagram illustrating a configuration of an audio transmission system 70 according to a second example.

The audio transmission system 70 according to the second example has substantially the same configuration as that of the audio transmission system 20 according to the first example illustrated in FIG. 8. Therefore, substantially the same constituent element and circuit are denoted by the same reference numerals, and detailed description thereof will not be repeated except for differences from the first example.

Each of the one or more slave devices 24 according to the second example includes an input circuit 72 in place of the one or more ADCs 52 (FIG. 8).

The input circuit 72 acquires an audio signal output from each of the one or more microphones 36 that are provided corresponding to the slave device 24. The input circuit 72 also acquires a frame signal and a bit clock output from the slave circuit 34. The input circuit 72 then performs digital-to-analog conversion on the audio signal output from each of the one or more microphones 36 to generate audio data representing audio collected by each of the one or more microphones 36. The input circuit 72 gives one or more pieces of the generated audio data to the slave circuit 34 in synchronization with the bit clock.

The audio transmission system 70 according to the second example having the configuration as described above can prevent output of audio with loud volume similarly to the audio transmission system 20 according to the first example.

Each of the one or more slave devices 24 in the audio transmission system 70 according to the second example may further include the stop circuit 62 similarly to the modification of the first example. In a case where each of the one or more slave devices 24 includes the stop circuit 62, the signal processing circuit 54 of the master device 22 according to the second example does not necessarily perform the processing of limiting output of the audio signals of N channels in a case where the level of each of the audio signals of N channels is larger than the threshold value set in advance.

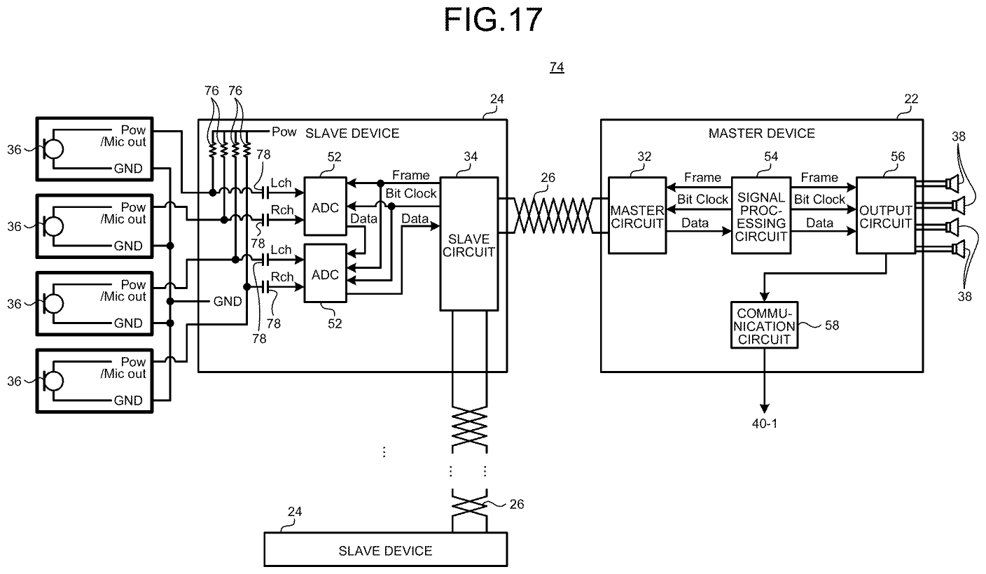

FIG. 17 is a diagram illustrating a configuration of an audio transmission system 74 according to a third example.

The audio transmission system 74 according to the third example has substantially the same configuration as that of the audio transmission system 20 according to the first example illustrated in FIG. 8. Therefore, substantially the same constituent element and circuit are denoted by the same reference numerals, and detailed description thereof will not be repeated except for differences from the first example.

Each of the microphones 36 according to the third example is a two-terminal type including a power supply signal common terminal (Pow/Mic out) and a ground terminal (GND). The power supply signal common terminal receives supply of DC power from the slave device 24 corresponding to the microphone 36, and outputs an analog audio signal to the slave device 24 corresponding to the microphone 36.

Each of the one or more slave devices 24 according to the third example includes one or more resistors 76 and one or more capacitors 78.

The one or more resistors 76 correspond to the one or more microphones 36 connected to the slave device 24 on a one-to-one basis. Each of the one or more resistors 76 is connected between the power supply signal common terminal (Pow/Mic out) of the corresponding microphone 36 and internal power supply potential (Pow) of the slave device 24. Due to this, each of the one or more resistors 76 can supply DC power to the power supply signal common terminal of the corresponding microphone 36.

The one or more capacitors 78 correspond to the one or more microphones 36 connected to the slave device 24 on a one-to-one basis. Each of the one or more capacitors 78 is connected between the power supply signal common terminal of the corresponding microphone 36 and the ADC 52. Due to this, each of the one or more capacitors 78 can remove a DC component of the internal power supply potential (Pow) from the analog audio signal output from the corresponding microphone 36, and supply the audio signal to the ADC 52.

The audio transmission system 74 according to the third example having the configuration described above can prevent output of audio with loud volume similarly to the audio transmission system 20 according to the first example.

Each of the one or more slave devices 24 in the audio transmission system 74 according to the third example may further include the stop circuit 62 similarly to the modification of the first example. In a case where each of the one or more slave devices 24 includes the stop circuit 62, the signal processing circuit 54 of the master device 22 according to the third example does not necessarily perform the processing of limiting output of the audio signals of N channels in a case where the level of each of the audio signals of N channels is larger than the threshold value set in advance.

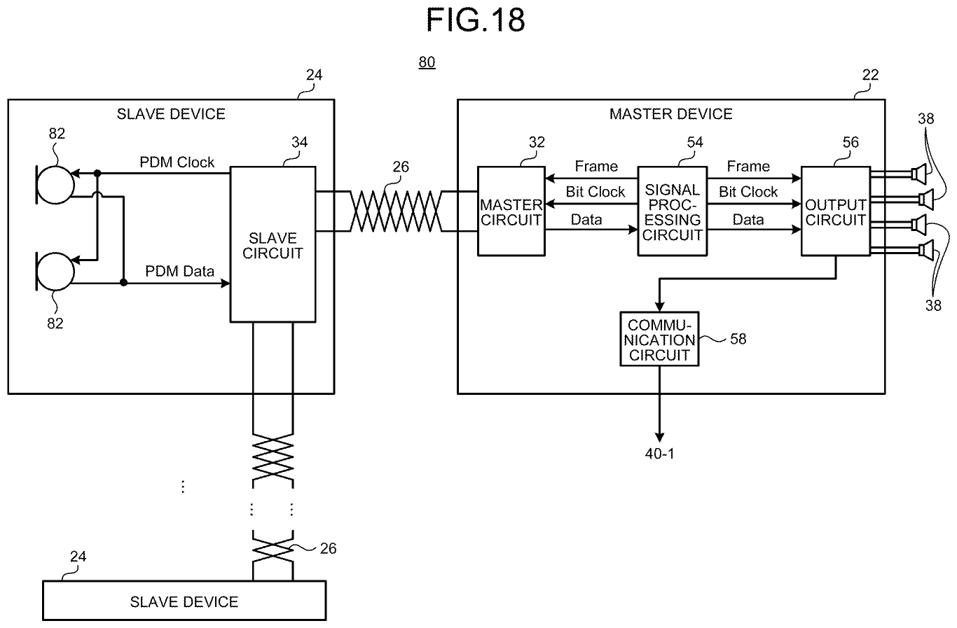

FIG. 18 is a diagram illustrating a configuration of an audio transmission system 80 according to a fourth example.

The audio transmission system 80 according to the fourth example has substantially the same configuration as that of the audio transmission system 20 according to the first example illustrated in FIG. 8. Therefore, substantially the same constituent element and circuit are denoted by the same reference numerals, and detailed description thereof will not be repeated except for differences from the first example.

The audio transmission system 80 according to the fourth example includes digital microphones 82 in place of the microphones 36.

Each of the N digital microphones 82 is provided in one of the one or more slave devices 24. Each of the one or more slave devices 24 according to the fourth example has a configuration not including the ADC 52.

Each of the N digital microphones 82 receives a Pulse Density Modulation (PDM) clock from the slave circuit 34 included in the corresponding slave device 24. Each of the N digital microphones 82 outputs PDM data as audio data obtained by performing pulse density modulation (PDM) on an audio signal on the basis of the PDM clock.

The slave circuit 34 receives the PDM data from the corresponding digital microphone 82. The slave circuit 34 converts the PDM data into serial audio data synchronized with a bit clock that is generated inside. The slave circuit 34 then transmits the serial audio data to the master circuit 32 via the one or more transmission lines 26.

The audio transmission system 74 according to the third example having the configuration as described above can prevent output of audio with loud volume similarly to the audio transmission system 20 according to the first example.

Each of the one or more slave devices 24 in the audio transmission system 74 according to the third example may further include the stop circuit 62 similarly to the modification of the first example.

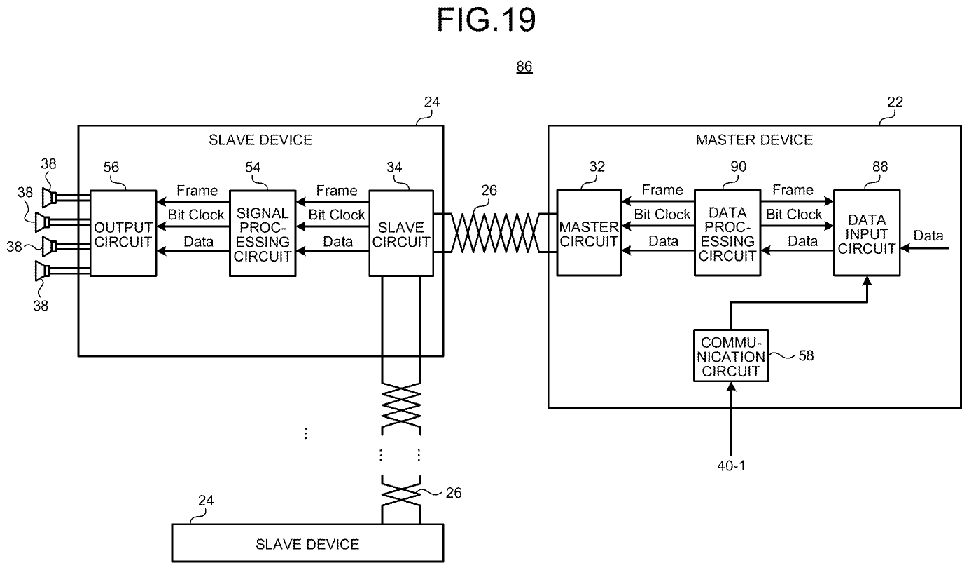

FIG. 19 is a diagram illustrating a configuration of an audio transmission system 86 according to a fifth example.

The audio transmission system 86 according to the fifth example includes a circuit having substantially the same configuration as that of the audio transmission system 20 according to the first example illustrated in FIG. 8. Therefore, substantially the same constituent element and circuit are denoted by the same reference numerals, and detailed description thereof will not be repeated except for differences from the first example.

The audio transmission system 86 according to the fifth example includes the master device 22, the one or more slave devices 24, the one or more transmission lines 26, and the speakers 38.

The master device 22 includes a data input circuit 88, a data processing circuit 90, the master circuit 32, and the communication circuit 58.

The data input circuit 88 receives audio data of the N channels from an external device, for example. The data input circuit 88 gives the received audio data of N channels to the data processing circuit 90.

The data processing circuit 90 gives the frame signal and the bit clock to the data input circuit 88 and the master circuit 32. The data processing circuit 90 receives audio data of the N channels synchronized with the frame signal and the bit clock from the data input circuit 88, and performs predetermined signal processing. The data processing circuit 90 then gives audio data of the N channels subjected to the predetermined signal processing to the master circuit 32.

The master circuit 32 receives the frame signal and the bit clock from the data processing circuit 90. At the same time, the master circuit 32 receives audio data of the N channels from the data processing circuit 90. The master circuit 32 serially transmits, to the transmission line 26, each piece of audio data of the N channels in a corresponding transmission/reception period out of the N transmission/reception periods for each reference period on the basis of the frame signal and the bit clock received from the data processing circuit 90. In this way, in the fifth example, the master circuit 32 functions as the audio transmitter that transmits the audio data.

The communication circuit 58 receives the audio data of at least one channel out of the pieces of audio data of N channels from the information processing device 40-1 via the communication bus. The communication circuit 58 then gives the received audio data to the data input circuit 88 as one of the pieces of audio data of N channels. In a case where the information processing device 40-1 is not connected to the audio transmission system 86, the communication circuit 58 does not receive the audio data.

Each of the one or more slave devices 24 includes the slave circuit 34, the signal processing circuit 54, and the output circuit 56.

The slave circuit 34 receives the frame signal and the bit clock from the signal processing circuit 54. The slave circuit 34 receives, via the transmission line 26, the audio data of one or more channels corresponding to the audio output from the slave device 24, out of the pieces of audio data of N channels. More specifically, the slave circuit 34 receives the audio data of one or more channels transmitted to the one or more transmission lines 26 in a corresponding transmission/reception period out of the N transmission/reception periods for each reference period on the basis of the frame signal and the bit clock. The slave circuit 34 then transmits the received audio data of one or more channels to the signal processing circuit 54 in synchronization with the bit clock. In this way, in the fifth example, the slave circuit 34 functions as the audio receiver that receives the audio data.

The signal processing circuit 54 receives the audio data of one or more channels from the slave circuit 34 and performs predetermined audio signal processing on each piece of the received audio data of one or more channels. The signal processing circuit 54 gives the audio data of one or more channels subjected to the audio signal processing to the output circuit 56 together with the frame signal and the bit clock.

The output circuit 56 receives each piece of the audio data of one or more channels from the signal processing circuit 54. The output circuit 56 performs digital-to-analog conversion on respective pieces of the audio data of one or more channels received from the signal processing circuit 54 to generate audio signals of one or more channels. The output circuit 56 causes each of the generated audio signals of one or more channels to be output from the speaker 38. For example, the output circuit 56 gives each of the audio signals of one or more channels to one of the speakers 38.

In a case where the level of any piece of audio data out of the pieces of audio data of one or more channels received by the slave circuit 34 is larger than a threshold value, the signal processing circuit 54 limits the level of the audio data of one or more channels to be equal to or lower than a predetermined level.

For example, the signal processing circuit 54 determines whether the level of any piece of audio data out of the pieces of audio data of one or more channels is larger than the threshold value for each reference period. In a case where the level of any piece of audio data out of the pieces of audio data of one or more channels is larger than the threshold value, the signal processing circuit 54 limits the level of the audio data of one or more channels to be equal to or lower than a predetermined level thereafter.

The signal processing circuit 54 may stop output of audio data whose level is larger than the threshold value out of the pieces of audio data of one or more channels. In this case, the signal processing circuit 54 may stop output of all pieces of the audio data of one or more channels.

The audio transmission system 20 according to the fifth example as described above can prevent output of audio with loud volume from the slave device 24.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

With the audio transmission system and the slave device according to the present disclosure, output of audio with loud volume can be prevented.

What is claimed is:

1. An audio transmission system performing time-division multiplexing on audio data of N channels (N is an integral number equal to or larger than 1) for each reference period and transmitting multiplexed audio data, the N channels representing a number of channels determined in advance in accordance with a preset mode, the audio transmission system comprising:
a master circuit;
one or more slave circuits connected to the master circuit via one or more transmission lines by daisy chain topology; and
a signal processing circuit, wherein
each piece of audio data of the N channels corresponds to a different one of the one or more slave circuits, the each piece of audio data of the N channels being assigned to a different one of N transmission/reception periods obtained by time-dividing the reference period,
each of the one or more slave circuits includes a register to store a mode value representing the preset mode,
the master circuit writes the mode value onto the register included in the each of the one or more slave circuits,
the each of the one or more slave circuits
generates a bit clock in accordance with the mode value stored in the register, the bit clock being synchronized with a clock of data to be transmitted or received via the one or more transmission lines, and
serially transmits or receives a corresponding piece of audio data out of pieces of audio data of the N channels to/from the master circuit in the transmission/reception period assigned to the corresponding piece of audio data,
either one of the master circuit and the one or more slave circuits function as an audio transmitter to transmit audio data, and the other one function as an audio receiver to receive audio data, and
the signal processing circuit limits a level of audio data of the N channels to be equal to or smaller than a predetermined value in a case where a level of audio data received by the audio receiver is larger than a threshold value.

2. The audio transmission system according to claim 1, wherein
the master circuit transmits a synchronization signal synchronized with the reference period to the each of the one or more slave circuits via the one or more transmission lines, and
the each of the one or more slave circuits generates the bit clock in accordance with the mode value stored in the register and the synchronization signal.

3. The audio transmission system according to claim 2, wherein the each of the one or more slave circuits changes a frequency of the bit clock in accordance with the mode value stored in the register.

4. The audio transmission system according to claim 3, wherein
the master circuit functions as the audio receiver,
the each of the one or more slave circuits functions as the audio transmitter, and
the signal processing circuit limits the level of audio data of the N channels to be equal to or smaller than a predetermined value in a case where a level of a piece of audio data of the N channels received by the master circuit is larger than the threshold value.

5. The audio transmission system according to claim 4, further comprising an output circuit, wherein
the signal processing circuit performs audio signal processing on the each piece of audio data of the N channels received by the master circuit, and
the output circuit
receives the each piece of audio data of the N channels from the signal processing circuit,
performs digital-to-analog conversion on respective pieces of audio data of the N channels to generate audio signals of N channels, and
causes a speaker to output each of the generated audio signals of N channels.

6. The audio transmission system according to claim 5, further comprising a communication circuit that transmits/receives data to/from an information processing device via a communication bus,
wherein the communication circuit
acquires, from the output circuit, audio data of at least one channel out of audio data of the N channels, and
transmits the audio data acquired from the output circuit to the information processing device via the communication bus.

7. The audio transmission system according to claim 4, further comprising microphones, wherein
the each piece of audio data of the N channels represents audio collected by one of the microphones.

8. The audio transmission system according to claim 7, further comprising one or more analog-to-digital converters,
wherein each of the one or more analog-to-digital converters
corresponds to one or more of the microphones,
performs analog-to-digital conversion on an audio signal output from each of the corresponding one or more of the microphones at each sampling timing to generate one or more pieces of audio data synchronized with the bit clock at each sampling timing, and
gives one or more pieces of the generated audio data to a corresponding one of the one or more slave circuits.

9. The audio transmission system according to claim 3, wherein
the master circuit functions as the audio transmitter,
each of the one or more slave circuits functions as the audio receiver,
the signal processing circuit is provided correspondingly to each of the one or more slave circuits, and
the signal processing circuit limits a level of audio data received by a corresponding one of the one or more slave circuits to be equal to or smaller than a predetermined value in a case where the level of the received audio data is larger than the threshold value.

10. The audio transmission system according to claim 9, further comprising one or more output circuits that are provided correspondingly to the one or more slave circuits, wherein
the signal processing circuits performs audio signal processing on the audio data received by the corresponding slave circuit, and
each of the one or more output circuits
receives audio data from the signal processing circuit of a corresponding one of the one or more slave circuits,
performs digital-to-analog conversion on the received audio data to generate an audio signal, and
causes a speaker to output the generated audio signal.

11. An audio transmission system performing time-division multiplexing on audio data of N channels (N is an integral number equal to or larger than 1) for each reference period and transmitting multiplexed audio data, the N channels representing a number of channels determined in advance in accordance with a preset mode, the audio transmission system comprising:
a master circuit;
one or more slave circuits connected to the master circuit via one or more transmission lines by daisy chain topology; and
one or more stop circuits corresponding to the one or more slave circuits, wherein
each piece of audio data of the N channels corresponds to a different one of the one or more slave circuits, the each piece of audio data of the N channels being assigned to a different one of N transmission/reception periods obtained by time-dividing the reference period,
each of the one or more slave circuits includes a register to store a mode value representing the preset mode,
the master circuit writes the mode value onto the register included in the each of the one or more slave circuits,
the each of the one or more slave circuits
generates a bit clock in accordance with the mode value stored in the register, the bit clock being synchronized with a clock of data to be transmitted or received via the one or more transmission lines, and
serially transmits a corresponding piece of audio data out of pieces of audio data of the N channels to the master circuit in the transmission/reception period assigned to the corresponding piece of audio data, and
each of the one or more stop circuits causes a corresponding one of the one or more slave circuits to stop transmission of audio data to the master circuit in a case where a frequency of the bit clock generated by the corresponding slave circuit falls outside a frequency range set in advance.

12. A slave device in an audio transmission system, the audio transmission system including a master device and one or more slave devices connected to the master device via one or more transmission lines by daisy chain topology, the slave device comprising:
a slave circuit; and
a stop circuit, wherein
the audio transmission system performs time-division multiplexing on audio data of N channels (N is an integral number equal to or larger than 1) for each reference period and transmits multiplexed audio data, the N channels representing a number of channels determined in advance in accordance with a preset mode,
each piece of audio data of the N channels corresponds to a different one of the one or more slave circuits, the each piece of audio data of the N channels being assigned to a different one of N transmission/reception periods obtained by time-dividing the reference period,
the slave circuit includes a register to store a mode value representing the preset mode,
the master device writes the mode value onto the register,
the slave circuit
generates a bit clock in accordance with the mode value stored in the register, the bit clock being synchronized with a clock of data to be transmitted or received via the one or more transmission lines, and
serially transmits a corresponding piece of audio data of out of pieces of audio data of the N channels to the master device in the transmission/reception period assigned to the corresponding piece of audio data, and
the stop circuit causes the slave circuit to stop transmission of audio data to the master device in a case where a frequency of the bit clock generated by the slave circuit falls outside a frequency range set in advance.
